(19) United States
(12) Patent Application Publication
(10) Pub. No.: US 2011/0054055 A1
(43) Pub. Date: Mar. 3, 2011

(54) LOW-PHOSPHORUS LAMINATION ADDITIVES HAVING LOW EMISSION, IMPROVED INITIAL ADHESION AND IMPROVED HYDROLYSIS STABILITY

(75) Inventors: Sarah Schmitz, Essen (DE); Christian Eilbracht, Herne (DE)

(73) Assignee: EVONIK GOLDSCHMIDT GMBH, Essen (DE)

(21) Appl. No.: 12/873,800

(22) Filed: Sep. 1, 2010

(30) Foreign Application Priority Data
Sep. 2, 2009 (DE) 102009029089.3

(51) Int. Cl. C08G 18/00; C08K 5/49; B32B 37/00

(52) U.S. Cl. 521/155; 524/706; 524/147; 524/131; 156/60

(57) ABSTRACT

A composition is provided which is suitable for producing polyurethane systems appropriate for hot adhesive bonding. The composition includes from 0.1 to 20% by mass of an additive mixture comprising at least one organic phosphorus compound either alone or in combination with a crosslinker or extender.

### FIELD OF THE INVENTION

The present disclosure is directed to low-phosphorus lamination additives. More particularly, the present disclosure is directed to low-phosphorus additives which are used in polyurethane systems, in particular polyurethane foams, for the flame lamination of substrates, and also as laminates obtained using the lamination additives of the present application. The additives of the present disclosure display minimal emission and improved initial adhesion compared to conventional additives.

### BACKGROUND OF THE INVENTION

In the production of many articles in which flexible polyurethane systems, in particular polyurethane foams, are used, there is a need to obtain an adhesive bond between the polyurethane system and the substrate, e.g., wood, textiles, metals or plastic material. One method of joining foams or coating foams with textiles, and without using additional adhesives, is the method of hot adhesive bonding. In such a method, it is usual to convert the surface of the polyurethane system (polyurethane foam) into a sticky mass by action of heat and then laminate the substrate onto the converted surface of the polyurethane system. After cooling of the sticky mass, the latter becomes solid and a very durable bond between the polyurethane system and substrate is obtained.

This method was originally suitable exclusively for polyurethanes of the polyester type since polyurethanes of the polyether type do not solidify sufficiently after cooling, and generally have very poor adhesion, and in particular initial adhesion to, for example, textiles.

U.S. Pat. No. 3,205,120 for the first time described heat-treated polyurethane foam laminates based on the cheaper polyether urethane foams. Apart from a conventional polyether, a small proportion of a low molecular weight polyol selected from among polyoxyalkylene polyols, hydroxyaliphatic esters of a phosphorus-containing acid and hydroxyl-containing natural oils is used.

U.S. Pat. No. 3,497,416 describes closed-celled polyurethane foam laminates based on polyether polyurethane foams. The foam contains a reaction product of a polyether polyol and a polyisocyanate which is obtained by reaction of dipropylene glycol or dibutylene glycol with an excess of an aromatic polyisocyanate. In the '416 disclosure, numerous process difficulties attributed to the high reactivity of polyether polyols are identified.

U.S. Pat. No. 3,131,105 describes a method of producing laminate structures, in which a coating containing an inflammable substance is applied to the surface of a polyurethane foam. The coating is subsequently ignited and a layer of a material which is to be joined to the surface is applied to the plasticized foam surface under pressure. This prior art method is suitable for both types of polyurethane foams. The addition of additives to the foams is not disclosed.

U.S. Pat. Nos. 3,142,650 and 3,142,651 describe the production of polyurethane starting out from hydroxyl-containing phosphite esters, e.g., a tris(polypropylene glycol) phosphite. The production of flame laminates based on polyurethane foam is not described.

DE 4236767 proposes increasing the flame laminatability by adding ester PUR foam in powder form to the ether PUR foam. However, this has the disadvantage of the increasing hydrolysis instability with increasing content of polyester polyol.

U.S. Pat. No. 4,135,042 describes the use of phosphites as flame retardants in polyurethane foams containing halogenated phosphate polyester additives. The '042 patent does not, however, describe the production of flame laminates based on polyurethane foam.

The use of linear diols is said to increase the thermoplasticity of polyether polyurethanes and thus lead to reversible melting of the foam (see, for example, U.S. Pat. No. 5,900,087). However, it is known from the literature that bonding between foam and substrate occurs only when the temperatures reached are significantly higher than those required merely for deformation as a result of thermoplasticity (see, for example, K. F. Hager, M. B. Brodbeck; Journal of Cellular Plastics 1968).

The addition of polyols based on natural oil (NOPs) has been described in WO 2009017973A1 as aiding flame lamination. NOPs, too, contain a certain proportion of polyester polyols and thus contribute to reducing the hydrolysis stability of foams. Since NOPs are natural products, the processability is subject to some fluctuation. Problems often occur as a result of incompatibility of the various polyols, so that other additives such as emulsifiers have to be added. In addition, NOPs often give the foams a characteristic, undesirable odor.

EP 0 189 644 describes a flame-laminatable polyurethane composition which contains at least one organic phosphorus additive which is able to increase the laminatability. Organic phosphorus compounds mentioned are organic phosphites, organic phosphonates and organic phosphates. The use of organic phosphorus compounds likewise leads to hydrolysis sensitivity.

In all the above-described processes of the prior art, polyether foams having a more or less improved laminatability are obtained. However, compared to polyester foams, the above-described additives are not able to give corresponding adhesion, in particular initial adhesion. In addition, improvement in respect of emission as a result of the additives added was not taken into account in the above mentioned documents. In the case of additives based on phosphorus compounds, a reduction in the hydrolysis stability has to be accepted.

### SUMMARY OF THE INVENTION

The present disclosure provides alternative hot adhesive bonding additives which avoid one or more of the disadvantages of the above mentioned additives. In particular, a very hydrolysis-stable, low-emission, halogen-free additive which displays reduced smoking during hot adhesive bonding is provided in this disclosure. The bond formed between foam and substrate is pronounced after only a few minutes and is at least equal to, or preferably greater, than the bonding in the foam itself after one hour to a number of hours. The foam surface typically does not harden so that, for example, seating comfort in the case of, for example, furniture such as automobile seats is not adversely affected.

In particular, this disclosure provides compositions which are suitable for producing polyurethane systems appropriate for hot adhesive bonding. More particularly, the present disclosure provides compositions that comprise from 1 to 15% by mass, preferably from 2.5 to 10% by mass and particularly preferably from 4.5 to 8.5% by mass, based on the total composition, of an additive mixture which comprises at least one organic phosphorus compound either alone or in combination with at least one compound (X) which has at least two functional groups capable of reacting with isocyanate groups (isocyanate-reactive groups).

The present disclosure further provides a polyurethane system, in particular a polyurethane foam, which can be obtained by foaming a composition according to the present application.

The present disclosure further provides a laminated structure containing a polyurethane system according to the present application hot adhesively bonded to a substrate as well as a process for producing such a structure.

The disclosed compositions of the present disclosure have the advantage that the addition thereof enables both the hydrolysis stability and also the initial adhesion of the foams to be significantly increased compared to those of foams produced without corresponding additives (e.g., crosslinkers). Moreover, the disclosed compositions provide very stable bonds, in particular bonds which are stronger than the bonds in the foam itself, between the polyurethane system and the substrate after relatively short pressing together of foam and substrate. As a result of the preferably predominant proportion of the compound (X) which has at least two functional groups capable of reacting with isocyanate groups in combination with the organic phosphorus compound in the additive mixture, the phenomenon of smoke formation on heating can be reduced.

### BRIEF DESCRIPTION OF THE DRAWINGS

FIG. 1 is a graph illustrating the force required for detaching a substrate from a polyurethane foam after a lamination time of one hour for use of different concentrations of the various pure phosphorus compounds of formulae (Ia) to (Ic) according to Examples 1 to 15.

FIG. 2 is a graph comparing initial adhesion of the various compounds of formulae (Ia) to (Ic) for equal amounts used of 5 parts or when using crosslinkers and reducing the amount of organic phosphorus compound.

FIG. 3 is graph illustrating the force required for detaching the substrate from polyurethane foam for various compositions containing a compound of formula (Ic) plotted against the lamination time.

### DETAILED DESCRIPTION

For the purposes of the present disclosure, the term hot adhesive bonding encompasses the methods of flame lamination, hot lamination or infrared lamination, ultrasonic or other high-frequency adhesive bonding and fusion.

The compositions of the present disclosure, the polyurethane foams themselves and their uses for producing laminates are described by way of example below without this disclosure being restricted to these illustrative embodiments. Where ranges, general formulae or classes of compounds are indicated below, these are intended to encompass not only the respective ranges or groups of compounds which are explicitly mentioned but also all subranges and subgroups of compounds which can be obtained by leaving out individual values (ranges) or compounds. When documents are cited in the present description, their contents, in particular in respect of the facts to which reference is made, are fully incorporated by reference into the disclosure content of the present invention. If percentages are indicated in the following, these are, unless indicated otherwise, percentages by mass.

As mentioned above, the disclosed compositions, which are suitable for, or are used for producing polyurethane systems suitable for hot adhesive bonding, comprise from 0.1 to 20% by mass, preferably from 1 to 10% by mass, more preferably from 2.5 to 8.5% by mass and particularly preferably from 4.5 to 5.5% by mass (based on the total composition) of an additive mixture comprising at least one organic phosphorus compound (I) selected from among the compounds of formulae (Ia) to (Ic)

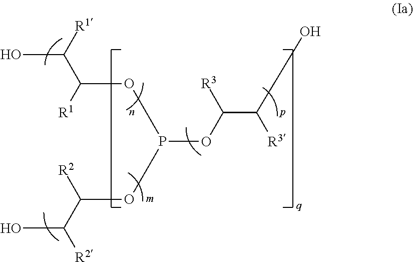

where m, n and p are identical or different and are each greater than or equal to 1, preferably from 2 to 30, preferably from 2.5 to 10, more preferably from 2.5 to 4,
q is greater than or equal to 1, preferably from 1 to 5, more preferably from 1 to 3, in particular 1, and
R¹, R^{1′}, R², R^{2′}, R³ and R^{3′} are identical or different and are each —H, -alkyl, in particular CH₃ or -phenyl, preferably —H or —CH₃, particularly preferably —H, where it may be advantageous for the radicals R¹, R² and R³ to be hydrogen radicals and the radicals R^{1′}, R^{2′} and R^{3′} to be methyl radicals or likewise hydrogen radicals,

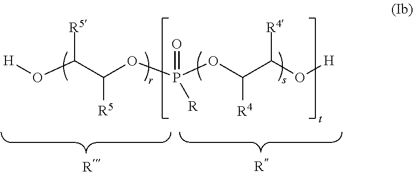

where the indices r are identical or different, preferably identical, and are each greater than or equal to 1, preferably from 2 to 30, more preferably from 2.5 to 10 and particularly preferably from 2.5 to 4,
the indices s are identical or different, preferably identical, and are each 0 or greater than or equal to 1, preferably from 2 to 30, more preferably from 2.5 to 10 and particularly preferably from 2.5 to 4,
t is greater than or equal to 1, preferably from 1 to 5, more preferably from 1 to 3, in particular 1,
R⁴, R^{4′}, R⁵ and R^{5′} are identical or different and are each —H, -alkyl, in particular CH₃ or -phenyl, preferably —H or —CH₃, particularly preferably —H, where it may be advantageous for the radicals R⁴ and R⁵ to be hydrogen radicals and the radicals R^{4′} and R^{5′} to be methyl radicals or likewise hydrogen radicals,
R is a hydrogen radical, alkyl radical, preferably having from 1 to 5, more preferably 1 or 2, carbon atoms, in particular a methyl radical, phenyl radical, R″ or R″, preferably a methyl radical, and
r+s is from 4 to 60, preferably from 5 to 20, preferably from 5 to 8, and

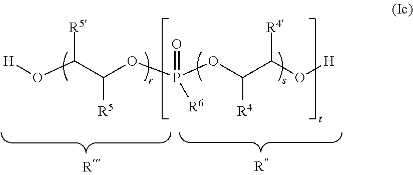

where r, s, t, R⁴, R⁵, R^{4′}, R^{5′}, R″ and R′″ are as defined for formula (Ib) and R⁶ is —(CH₂)ₒ—OH, where o is from 1 to 5, preferably from 1 to 2 and particularly preferably 1, where r+s is preferably from 4 to 60, more preferably from 5 to 20 and particularly preferably from 5 to 8, and at least one compound (X) which has at least two functional groups capable of reacting with isocyanate groups and has an equivalent mass of less than 400 g/mol or one or more compounds of the formula (Ic).

In one embodiment, the disclosed composition preferably contains an additive mixture which is a mixture of one or more compounds (X) with one or more organic phosphorus compounds (I).

The building blocks characterized by the indices m, n, p, q, r, s and t which are present in the compounds of formulae (Ia) to (Ic) can be identical (homopolyether) or different within a molecule. It can be advantageous for the building blocks to be identical in a compound or as a number average over all compounds of the respective formula and preferably either all be ethylene oxide units or all be propylene oxide units.

Preferred organic phosphorus compounds of the type (Ia) are those of the formula (Ia1)

P(—(OCR⁷H—CHR^{7′})ᵤ—OH)₃ (Ia1)

where the indices u are identical or different, preferably identical, and are each from 2 to 30, preferably from 2.5 to 10, more preferably from 2.5 to 4, and R⁷ and R^{7′} are identical or different and are each —H, —CH₃, -phenyl, preferably —H or —CH₃, particularly preferably —H, where, in particular, R⁷ is preferably —H and R⁷ is preferably —H or CH₃.

Preferred organic phosphorus compounds of the type (Ib) are those in which t is 1 and/or R is methyl. Preferred organic phosphorus compounds of the type (Ic) are those in which t is 1 and/or R⁶ is —(CH₂)ₒ—OH, where o is 1.

The values indicated for the indices m, n, o, p and q are, when mixtures of the respective compounds are present, averages (number average).

The organic phosphorus compounds of the formula (I) can be prepared, for example, as described in Houben-Weyl “Methoden der organischen Chemie” volume XII/2, 4th edition, p. 21, 69, 143 ff., 336. Further suitable synthetic methods may be found, for example, in J. P. H. Verheyden, J. G. Moffatt; J. Org. Chem. 35, 1970, p. 2319.

For the compounds of the formula (Ic) the proportion of organic phosphorus compounds in the additive mixture can preferably be from 1 to 100% by mass, more preferably from 5 to 50% by mass, particularly preferably from 10 to 30% by mass and particularly preferably from 15 to 25% by mass.

For the compounds of formulae (Ia) and (Ib), the proportion of organic phosphorus compounds in the additive mixture can preferably be from 1 to 99% by mass, more preferably from 5 to 50% by mass, particularly preferably from 10 to 30% by mass and particularly preferably from 15 to 25% by mass.

The organic phosphorus component can be a hydroxyl-containing organic phosphite, organic phosphonate or organic phosphate, while the compounds (X) (crosslinkers or extenders) are polyfunctional isocyanate-reactive compounds.

In particular, a synergistic effect is surprisingly achieved by the preferred combination of organic phosphorus compound (I) and compounds (X). Neither by use of the compounds (X) alone, nor of the phosphorus compounds (I) alone (with the exception of the compounds of formula (Ic)), at the same amount used, foams having a comparably strong or stronger initial adhesion and corresponding hydrolysis stability can be obtained. This synergistic effect becomes particularly clear when compounds of formula (Ic) are present in the mixture. The hydrolysis stability can be increased by replacement of a part of the compounds of formula (I) by a compound (X) without change of the performance or even with increasing performance of the obtained foam.

If used as a hot adhesive bonding additive, the disclosed composition can comprise compounds of formula (Ic) exclusively or else likewise preferably mixtures of compounds of formula (Ic) with one or more compounds (X).

As compounds (X), it is possible to use all compounds which comprise at least two, preferably two or three, isocyanate-reactive groups in the disclosed composition. The reactive groups can preferably be hydroxy and/or amino groups, more preferably appropriate primary or secondary groups. The equivalent weight (=number average molecular weight/functionality) should not exceed 400 g/mol, preferably 200 g/mol, particularly preferably 150 g/mol. Such compounds can, for example, be bifunctional, e.g., bisphenol A or ethylene oxide polyether polyols or propylene oxide polyether polyols based thereon. Furthermore, higher-functional crosslinkers, e.g., trifunctional crosslinkers such as glycerol or ethylene oxide polyether polyols or propylene oxide polyether polyols based on glycerol or else (di)pentaerythritol and ethylene oxide polyether polyols or propylene oxide polyether polyols based thereon can also be used.

In general, crosslinkers or extenders selected from the group consisting of diethanolamine, triethanolamine, diisopropylamine, ethylene glycol, glycerol, trimethylolpropane, sorbitol, erythritol, sucrose, butanediol, the isomers of phenylene-diamine, pentaerythritol, 2,4,6-triaminotoluene, isophoronediamine, diethyltoluenediamine, ethanolamine, hydrazine, bisphenol A, low molecular weight oxyalkylene adducts, in particular ethylene oxide adducts of polyfunctional amines, polyfunctional alcohols, amino alcohols and alcohol amines and mixtures thereof are used as compounds (X). Preferred additive mixtures comprise at least one compound (X) containing ethylene oxide units.

As compounds (X), the additive mixture preferably comprises glycerol polyethers having an average (number average) of preferably from 8 to 15, more preferably from 9 to 12, alkylene oxide units, in particular ethylene oxide units, and/or ethoxylated bisphenol A preferably having an average (number average) of from 5 to 7 ethylene oxide units, more preferably an average of 6 ethylene oxide units. Suitable glycerol polyethers can be procured, for example, under the trade names VORALUX® HF-501 (Dow Chemical), ARCOL® LG-168 (Bayer) or VORANOL® CP 4702 (Dow Chemical). Ethoxylated bisphenol A can, for example, be procured from Sigma-Aldrich.

The additive mixture present in the composition of this disclosure preferably comprises from 1 to 51 parts by mass of compounds of the formula (I), in particular (Ia), (Ib) and/or (Ic) or mixtures thereof, and from 49 to 99 parts by mass of compounds (X), preferably from 10 to 25 parts by mass of compounds of the formulae (Ia) to (Ic) or mixtures thereof and from 75 to 90 parts by mass of compounds (X) and more preferably from 15 to 25 parts by mass of compounds of the formulae (Ib) to (Ic) or mixtures thereof and from 75 to 85 parts by mass of compounds (X).

The composition of the present disclosure can contain all further components suitable for producing polyurethane systems, in particular polyurethane foams. In particular, the compositions of the present disclosure contain, in addition to the additive mixture, preferably at least one isocyanate component and at least one polyol component and also, if appropriate, one or more blowing agents and if appropriate one or more urethane and/or isocyanurate catalysts.

Customary formulations for producing polyurethane systems, in particular polyurethane foams, contain one or more organic isocyanates having two or more isocyanate functions as isocyanate component, one or more polyols having two or more groups which are reactive toward isocyanate as polyol component, optionally catalysts for the isocyanate-polyol and/or isocyanate-water and/or isocyanate trimerization reactions, water, optionally physical blowing agents, optionally flame retardants and, if appropriate, further additives.

Suitable isocyanates that can be employed are preferably all polyfunctional organic isocyanates, for example, diphenylmethane 4,4′-diisocyanate (MDI), toluene diisocyanate (TDI), hexamethylene diisocyanate (HMDI) and isophorone diisocyanate (IPDI). The mixture of MDI and highly condensed analogues having an average functionality of from 2 to 4 which is known as “polymeric MDI” (“crude MDI”) and also the various isomers of TDI in pure form or as isomer mixture are particularly useful.

As polyol components, preference is given to using polyols which have an equivalent weight (=number average molecular weight/functionality) of greater than 400 g/mol, preferably greater than 500 g/mol and particularly preferably greater than 750 g/mol. Preferred polyol components are compounds which have a number average molecular weight of from 1000 to 8000, preferably from 1500 to 6000.

Suitable polyols are, in particular, those having at least two, preferably from 2 to 8, more preferably from 3 to 5, H atoms which are reactive towards isocyanate groups. Preference is given to using polyether polyols. Such polyols can be prepared by known methods, for example, by anionic polymerization of alkylene oxides in the presence of alkali metal hydroxides or alkali metal alkoxides as catalysts with addition of at least one starter molecule containing from 2 to 3 reactive hydrogen atoms in bound form, or by cationic polymerization of alkylene oxides in the presence of Lewis acids, for example, antimony pentachloride or boron fluoride etherate, or by double metal cyanide catalysis. Suitable alkylene oxides preferably contain from 2 to 4 carbon atoms in the alkylene radical. Examples are ethylene oxide, 1,2-propylene oxide, tetrahydrofuran, 1,3-propylene oxide, 1,2- or 2,3-butylene oxide. Preference is given to using ethylene oxide and/or 1,2-propylene oxide. The alkylene oxides can be used individually, alternately in succession or as mixtures. As starter molecules, it is possible to use, for example, water or 2- and/or 3-hydric alcohols, e.g. ethylene glycol, 1,2- and 1,3-propanediol, diethylene glycol, dipropylene glycol, glycerol, trimethylolpropane, etc. Polyfunctional polyols such as sugar can also be used as starters. Preferred polyether polyols are polyoxypropylenepolyoxyethylene polyols which preferably have a functionality of from 2 to 8 and/or preferably a number average molecular weight of from 1000 to 8000, more preferably from 1200 to 3500.

Further polyols are known to those skilled in the art and may be found in, for example, EP-A-0 380 993 or U.S. Pat. No. 3,346,557, which are fully incorporated herein by reference.

For producing molded foams and highly elastic flexible foams, preference is given to using bifunctional and/or trifunctional polyether alcohols which have primary hydroxyl groups, in particular polyether alcohols having an ethylene oxide block at the end of the chain or polyether alcohols based only on ethylene oxide.

For producing slabstock flexible foams, preference is given to using bifunctional and/or trifunctional polyether alcohols which have secondary hydroxyl groups, in particular polyether alcohols having a propylene oxide block or random propylene oxide and ethylene oxide block at the end of the chain or polyether alcohols based only on propylene oxide blocks.

Suitable polyester polyols are based on esters of polybasic carboxylic acids (which may be either aliphatic, for example adipic acid, or aromatic, for example phthalic acid or terephthalic acid) with polyhydric alcohols (usually glycols).

A suitable ratio of isocyanate and polyol, expressed as index of the composition, is in the range from 10 to 1000, preferably from 80 to 350, where 100 indicates a molar ratio of the reactive isocyanate groups to reactive OH groups of 1:1.

Suitable catalysts that can be employed in this disclosure are substances which catalyze the gelling reaction (isocyanate-polyol), the blowing reaction (isocyanate-water) or the dimerization or trimerization of the isocyanate. Typical examples are the amines triethylamine, dimethylcyclohexylamine, tetramethylethylenediamine, tetramethylhexanediamine, pentamethyldiethylenetriamine, pentamethyldipropylenetriamine, triethylenediamine, dimethylpiperazine, 1,2-dimethylimidazole, N-ethylmorpholine, tris(dimethylaminopropyl)hexahydro-1,3,5-triazine, dimethylaminoethanol, dimethyl-aminoethoxyethanol and bis(dimethylaminoethyl)ether, tin compounds such as dibutyltin dilaurate or tin-octoate and potassium salts such as potassium acetate.

Suitable amounts to be used depend on the type of catalyst and are usually in the range from 0.05 to 5 pphp (=parts by weight based on 100 parts by weight of polyol) or from 0.1 to 10 pphp for potassium salts.

Suitable water contents that can be employed depend on whether or not physical blowing agents are used in addition to water. In the case of purely water-blown foams, the values are typically from 1 to 20 pphp, but if other blowing agents are additionally used, the amount to be used is reduced to usually from 0.1 to 5 pphp. To achieve higher foam densities, preference is given to using neither water nor other blowing agents.

Suitable physical blowing agents that can be employed in this disclosure are gases, for example liquefied CO₂, and volatile liquids, for example hydrocarbons having 4 or 5 carbon atoms, preferably cyclopentane, isopentane and n-pentane, fluorinated hydrocarbons, preferably HFC 245fa, HFC 134a and HFC 365mfc, chlorofluorocarbons, preferably HCFC 141b, oxygen-containing compounds such as methyl formate and dimethoxymethane, or chlorinated hydrocarbons, preferably dichloromethane and 1,2-dichloroethane. Furthermore, ketones (e.g., acetone) or aldehydes (e.g., methylal) are suitable as blowing agents.

Apart from water and, if appropriate, physical blowing agents, it is also possible to use other chemical blowing agents which react with isocyanates to evolve gas, for example formic acid or carbonates.

Suitable flame retardants that can be employed are preferably liquid organic phosphorus compounds such as halogen-free organic phosphates, e.g., triethyl phosphate (TEP), halogenated phosphates, e.g., tris(1-chloro-2-propyl)phosphate (TCPP) and tris(2-chloroethyl)phosphate (TCEP), and organic phosphonates, e.g., dimethyl methanephosphonate (DMMP), dimethyl propanephosphonate (DMPP), or solids such as ammonium polyphosphate (APP) and red phosphorus. Furthermore, halogenated compounds, for example, halogenated polyols, and also solids such as expandable graphite and melamine are suitable as flame retardants.

The polyurethane system of the present disclosure or the polyurethane foam of the present disclosure can be obtained by processing or foaming a composition according to the present disclosure. Preferred polyurethane systems or foams according to the present disclosure comprise from 0.05 to 10% by mass, preferably from 0.1 to 5% by mass and particularly preferably from 0.5 to 2% by mass, of organic phosphorus compounds (I) or organic phosphorus compounds (I) incorporated by reaction, based on the system or the foam. The content can be determined in a simple way by determining the phosphorus content from the molecular weight of the phosphorus compounds used. Polyurethane systems or polyurethane foams having preferred phosphorus contents which can be calculated from the above mentioned amounts to be used are therefore likewise provided by the present disclosure.

The processing of the composition to form polyurethane systems, in particular polyurethane foams, can be carried out by all methods with which a person skilled in the art will be familiar, for example in manual mixing processes or preferably with the aid of high-pressure foaming machines. It is also possible to use batch processes, for example for the production of molded foams, refrigerators and panels, or continuous processes, for example in the case of insulation boards, metal composite elements, blocks or spray processes.

The laminated structure of the present disclosure contains or consists of a polyurethane system, in particular polyurethane foam, which is hot adhesively bonded to a substrate. As substrates, the structure can contain, for example, a woven fabric, a nonwoven or a felt, a natural or synthetic fibre such as cotton, wool, silk, linen, jute, sisal, Nylon, polyester, polyacrylonitrile, Rayon, polyurethane Spandex, a plastic film, e.g., a film produced using polyvinyl chloride, polyethylene, polypropylene, polystyrene, a metal, a wood or a composite.

The laminated structure of the present disclosure can be obtained by the process of this disclosure for producing a laminated structure, which is characterized in that a polyurethane system according to the present disclosure, in particular a polyurethane foam according to the present disclosure, is hot adhesively bonded to a substrate.

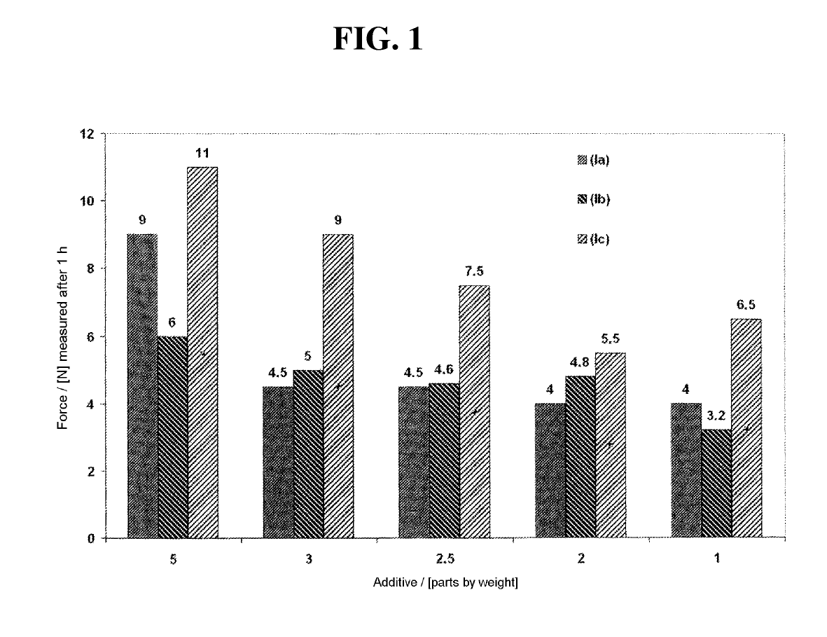

Reference is now made to FIGS. 1-3 which show some aspects of the present disclosure.

In FIG. 1, the force required for detaching a substrate from a polyurethane foam after a lamination time of one hour is shown for use of different concentrations of the various pure phosphorus compounds of formulae (Ia) to (Ic) as per Examples 1 to 15. It can easily be seen that for use of the additive (Ic) according to the present disclosure, the force required for breaking the hot adhesive bond is greatest when five parts are used. Compared to the compounds of type (Ia) and (Ib), the use of compounds of formula (Ic) also results in significantly greater adhesion at significantly smaller amounts used. After a lamination time of 60 minutes, laminates having very high adhesion are obtained even when using only 3 parts of the compound of type (Ic). Here, forces of about 9 N are necessary to detach the foam from the substrate.

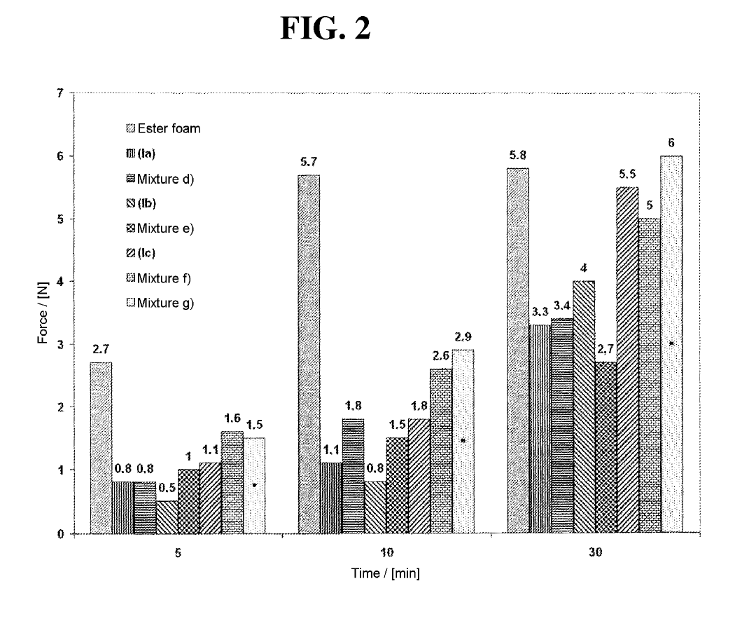

FIG. 2 compares the initial adhesion of various compounds of formulae (Ia) to (Ic) for equal amounts used of 5 parts or when using crosslinkers and reducing the amount of organic phosphorus compound.

Particularly in the case of compounds of formulae (Ib) and (Ic), it can be seen that the initial adhesion, in particular after 5 and 10 minutes, is greatly increased by the addition of crosslinker (X) although the amount of organic phosphorus compound used is lower by 80% by mass. After a lamination time of 30 minutes, better adhesion than in the case of an ester foam is observed when using the synergistic mixture of (Ic) with, for example, an ethoxylated bisphenol A (mixture g)).

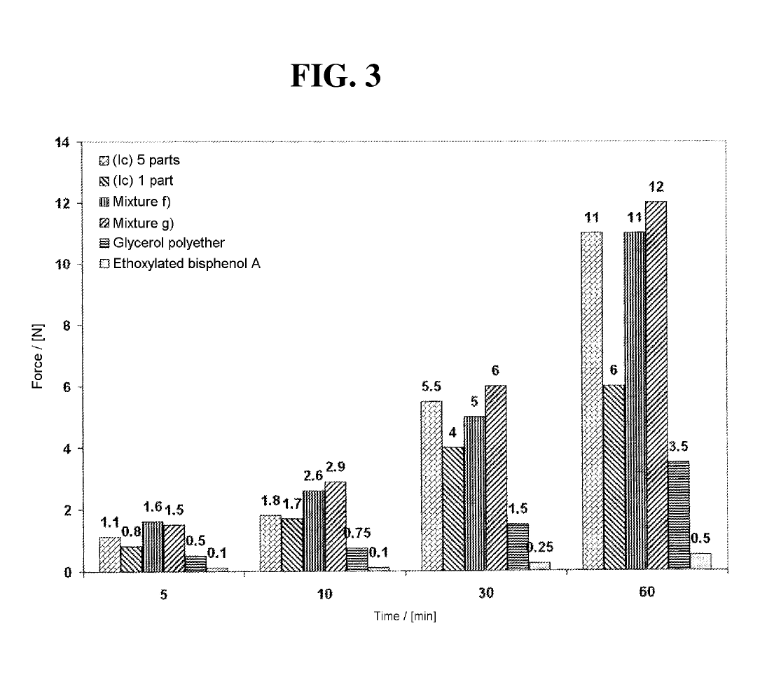

In FIG. 3, the force required for detaching a substrate from a polyurethane foam is once again shown for various compositions containing a compound of formula (Ic) plotted against the lamination time. It can easily be seen that when using only one part of the compound of formula (Ic), the final strength is significantly lower than when using five parts of the compound (Ic) or when five parts of the synergistic mixture (f) or (g) comprising only a small proportion of the compound (Ic) are added. Very similar adhesion results at the same time when using five parts of the compound (Ic) compared to the adhesion when five parts of the mixture are added. After a lamination time of about 60 minutes, tearing of the foam occurs in Examples 11 and 37, and a very high peeling force of 12 N is obtained in Example 41 because of the very good adhesion of the foam to the textile.

The present disclosure is now described by way of example in the examples shown below without the invention, whose scope is determined by the total description and the claims, being restricted to the embodiments mentioned in the examples.

### EXAMPLES

### Production of Polyurethane Foams

To produce the polyurethane foams, the following formulation was used: 100 parts by weight of a polyetherol comprising ethylene oxide units (EO) and propylene oxide units (PO) (hydroxyl number=47 mg KOH/g, from 11 to 12% by weight of EO based on the sum of EO and PO), 3 parts by weight of water, 0.8 parts by weight of TEGOSTAB® B 8228 (brand of Th. Goldschmidt AG) (silicone stabilizer), 0.15 part by weight of a tertiary amine (TEGOAMIN® B-75, a product of Evonik Goldschmidt GmbH), variable parts by weight of toluene diisocyanate T 80 (index 105) and also a variable amount of KOSMOS® 29 (Evonik Goldschmidt GmbH) (tin octoate) and a variable amount of the appropriate flame lamination additive.

Foaming was carried out using 200 g of polyol and the other constituents of the formulation were scaled accordingly. Table 1 summarizes the variable constituents of the formulations of the example foams 1 to 43.

To carry out foaming, polyol, water, amine, tin catalyst, flame lamination additive and silicone stabilizer were mixed well with stirring. After addition of the isocyanate, the mixture was stirred for 7 seconds at 3000 rpm by means of a stirrer. The mixture obtained was poured into a paper-lined wooden box (base area 17 cm×17 cm). This gave a foam which after storage for one day was cut into 4.3 cm (width)×14 cm (length)×1 cm (height) slices.

TABLE 1
Variable constituents of the formulations of example foams 1 to 43.

| | According to | | | |
|---|---|---|---|---|
| Example | the present | | Additive | Lamination |
| No. | application | Additive^{[1]} | [parts by wt.] | time [min] |
| 1 | No | a) | 5 | 60 |
| 2 | No | a) | 3 | 60 |
| 3 | No | a) | 2.5 | 60 |
| 4 | No | a) | 2 | 60 |
| 5 | No | a) | 1 | 60 |
| 6 | No | b) | 5 | 60 |
| 7 | No | b) | 3 | 60 |
| 8 | No | b) | 2.5 | 60 |
| 9 | No | b) | 2 | 60 |
| 10 | No | b) | 1 | 60 |
| 11 | Yes | c) | 5 | 60 |
| 12 | Yes | c) | 3 | 60 |
| 13 | Yes | c) | 2.5 | 60 |
| 14 | Yes | c) | 2 | 60 |
| 15 | Yes | c) | 1 | 60 |
| 16 | No | a) | 5 | 5 |
| 17 | No | a) | 5 | 10 |
| 18 | No | a) | 5 | 30 |
| 19 | Yes | d) | 5 | 5 |
| 20 | Yes | d) | 5 | 10 |
| 21 | Yes | d) | 5 | 30 |
| 22 | No | b) | 5 | 5 |
| 23 | No | b) | 5 | 10 |
| 24 | No | b) | 5 | 30 |
| 25 | Yes | e) | 5 | 5 |
| 26 | Yes | e) | 5 | 10 |
| 27 | Yes | e) | 5 | 30 |
| 28 | Yes | c) | 5 | 5 |
| 29 | Yes | c) | 5 | 10 |
| 30 | Yes | c) | 5 | 30 |
| 31 | Yes | f) | 5 | 5 |
| 32 | Yes | f) | 5 | 10 |
| 33 | Yes | f) | 5 | 30 |
| 34 | Yes | c) | 1 | 5 |
| 35 | Yes | c) | 1 | 10 |
| 36 | Yes | c) | 1 | 30 |
| 37 | Yes | f) | 5 | 60 |
| 38 | Yes | g) | 5 | 5 |
| 39 | Yes | g) | 5 | 10 |
| 40 | Yes | g) | 5 | 30 |
| 41 | Yes | g) | 5 | 60 |
| 42 | No | h) | 5 | 60 |
| 43 | No | i) | 5 | 60 |

^{[1]}a) = tris(dipropylene glycol) phosphite
b) = di(polyoxyethylene) methylphosphonate
c) = di(polyoxyethylene) hydroxymethylphosphonate
d) = 1 part by mass of tris(dipropylene glycol) phosphite + 4 parts by mass of glycerol polyether
e) = 1 part by mass of di(polyoxyethylene) methylphosphonate + 4 parts by mass of glycerol polyether
f) = 1 part by mass of di(polyoxyethylene) hydroxymethylphosphonate + 4 parts by mass of glycerol polyether
g) = 1 part by mass of di(polyoxyethylene) hydroxymethylphosphonate + 4 parts by mass of ethoxylated bisphenol A
h) = glycerol polyether
i) = bisphenol A (ethoxylated) from Sigma-Aldrich

The method of synthesizing the organic phosphorus compounds used is comprehensively described in Houben-Weyl “Methoden der organischen Chemie” volume XII/2, 4th edition, p. 21, 69, 143 ff., 336. Further synthetic steps may be found in J. P. H. Verheyden, J. G. Moffatt; J. Org. Chem. 35, 1970, p. 2319.

The flame lamination was carried out manually in the laboratory, as follows:

The foam specimen was placed on a refractory carriage which was conveyed by means of compressed air on the press of a button past the burner flame at a speed of 7 cm/s. The burner was a commercial camping gas burner operated using butane gas bottles. The nozzle of the burner is inclined downward and is at a distance of 6 cm from the foam. The amount of gas supplied was set so that a blue flame was obtained. After the foam had been conveyed past the flame, a cut-to-measure piece of textile was placed on the foam. The laminated foam was then placed between two tiles and placed under a constant gentle pressure for a variable time x (lamination time: from 5 min to 24 h) with the aid of a stand.

The adhesive strength (peeling tests) was measured in accordance with DIN EN ISO 8067, 07/1995, with a peeling speed of 100 mm/min being selected.

Each foam was laminated four times and the adhesive strength was determined in each case. The values reported in Table 2 are therefore means of four measurements.

The results are summarized in Table 2.

TABLE 2
Results of the determination of the adhesive strength of the foams

| Example No. | Lamination time [min] | Peeling force [N] |
|---|---|---|
| 1 | 60 | 9.0 |
| 2 | 60 | 4.5 |
| 3 | 60 | 4.5 |
| 4 | 60 | 4.0 |
| 5 | 60 | 4.0 |
| 6 | 60 | 6.0 |
| 7 | 60 | 5.0 |
| 8 | 60 | 4.6 |
| 9 | 60 | 4.8 |
| 10 | 60 | 3.2 |
| 11 | 60 | Tearing |
| 12 | 60 | 9.0 |
| 13 | 60 | 7.5 |
| 14 | 60 | 5.5 |
| 15 | 60 | 6.5 |
| 16 | 5 | 0.8 |
| 17 | 10 | 1.1 |
| 18 | 30 | 3.3 |
| 19 | 5 | 0.8 |
| 20 | 10 | 1.8 |
| 21 | 30 | 3.4 |
| 22 | 5 | 0.5 |
| 23 | 10 | 0.8 |
| 24 | 30 | 4.0 |
| 25 | 5 | 1.0 |
| 26 | 10 | 1.5 |
| 27 | 30 | 2.7 |
| 28 | 5 | 1.1 |
| 29 | 10 | 1.8 |
| 30 | 30 | 5.5 |
| 31 | 5 | 1.6 |
| 32 | 10 | 2.6 |
| 33 | 30 | 5.0 |
| 34 | 5 | 0.8 |
| 35 | 10 | 1.7 |
| 36 | 30 | 4.0 |
| 37 | 60 | Tearing |
| 38 | 5 | 1.5 |
| 39 | 10 | 2.9 |
| 40 | 30 | 6.0 |
| 41 | 60 | 12.0 |
| 42 | 60 | 3.5 |
| 43 | 60 | 0.5 |

Measurement of the Hydrolysis Stability

The hydrolysis stability was determined by a method based on the test method ASTM D 1564-71. Here, the conditions 5.1.2 were employed. The heating and drying cycles were carried out a total of three times for each foam and the decrease in the compression load deflection after 3 cycles was determined.

Table 3 summarizes the results of the hydrolysis stability measurements.

TABLE 3
Results of the compression load deflection (CLD) measurements
for determining the hydrolysis stability

| | | Phosphorus | CLD 40% | CLD 40% | | CLD loss |
|---|---|---|---|---|---|---|
| | According to | content of the | [kPa] | [kPa] | CLD loss | compared |
| No. | the invention | additive [%] | beforehand | afterwards | [%] | to 45 [%] |
| 1 | no | 7.3 | 2.9 | 1.4 | 52 | 5 |
| 6 | no | 12 | 4.5 | 2.0 | 56 | 1 |
| 11 | yes | 7.75 | 4.4 | 2.1 | 52 | 5 |
| 19 | yes | 1.55 | 3.5 | 2.2 | 37 | 20 |
| 25 | yes | 1.55 | 3.6 | 2.1 | 42 | 15 |
| 31 | yes | 1.55 | 3.8 | 2.2 | 42 | 15 |
| 38 | yes | 1.55 | 4.0 | 2.5 | 38 | 19 |
| 44* | no | — | 3.3 | 2.1 | 36 | 21 |
| 45** | no | — | 4.4 | 1.9 | 57 | 0 |

*Polyether polyol polyurethane foam without additive
**Polyester polyol polyurethane foam without additive

It can clearly be seen from the results that the hydrolysis stability is unambiguously increased by use of the additive mixture. Examples 19, 25, 31 and 38 show that with a percentage decrease in the compression load deflection of from 37 to 42% they are within the range of the decrease in the compression load deflection of a conventional polyether polyurethane foam without addition of additive (36%). The decrease in the compression load deflection of both an ester foam and the foams 1, 6 and 11, on the other hand, is in the order of 55% and thus about 20% higher compared to foams containing an optimized additive mixture.

While the present disclosure has been particularly shown and described with respect to preferred embodiments thereof, it will be understood by those skilled in the art that the foregoing and other changes in forms and details may be made without departing from the spirit and scope of the present disclosure. It is therefore intended that the present disclosure not be limited to the exact forms and details described and illustrated, but fall within the scope of the appended claims.

1. A composition suitable for producing polyurethane systems that are used for hot adhesive bonding, said composition comprising from 0.1 to 20% by mass based on the total composition of an additive mixture comprising at least one organic phosphorus compound (I) selected from compounds of formulae (Ia) to (Ic) 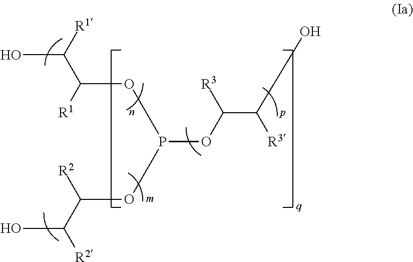
where m, n and p are identical or different and are each greater than or equal to 1,
q is greater than or equal to 1, and
R¹, R^{1′}, R², R^{2′}, R³ and R^{3′} are identical or different and are each —H, -alkyl or -phenyl, 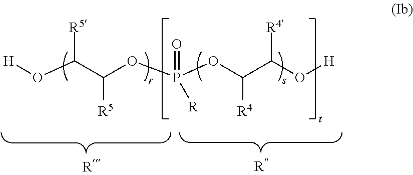
where the indices r are identical or different and are each greater than or equal to 1, the indices s are identical or different and are each 0 or greater than or equal to 1,
t is greater than or equal to 1,
R⁴, R^{4′}, R⁵ and R^{5′} are identical or different and are each —H, -alkyl or -phenyl,
R is a hydrogen radical, alkyl radical, phenyl radical, R″ or R′″ and
r+s is from 4 to 60, and 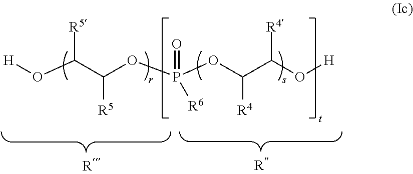
where r, s, t, R⁴, R⁵, R^{4′}, R^{5′}, R″ and R′″ are as defined for formula (Ib) and R⁶ is —(CH₂)ₒ—OH, where o is from 1 to 5,
and at least one compound (X) which has at least two functional groups capable of reacting with isocyanate groups (isocyanate-reactive groups) and has an equivalent mass of less than 400 g/mol, or of an additive mixture consisting of one or more compounds of the formula (Ic).

2. The composition according to claim 1, wherein the additive mixture is a mixture of one or more compounds (X) with one or more organic phosphorus compounds (I).

3. The composition according to claim 1, wherein the additive mixture comprises at least compound (X) containing ethylene oxide units.

4. The composition according to claim 1, wherein the additive mixture comprises a glycerol polyether, an ethoxylated bisphenol A as compound (X), or a combination thereof.

5. The composition according to claim 1, wherein the additive mixture comprises a glycerol polyether having from 9 to 12 alkylene oxide units, an ethoxylated bisphenol A having from 5 to 7 ethylene oxide units as compound (X) or a mixture thereof.

6. The composition according to claim 1, wherein the additive mixture comprises from 1 to 25 parts by mass of said organic phosphorus compounds (I) and from 75 to 99 parts by mass of said compounds (X).

7. The composition according to claim 1, further comprising at least one isocyanate component and at least one polyol component.

8. The composition according to claim 7 further comprising one of more blowing agents, one or more urethane catalysts, one or more isocyanurate catalysts or any mixture thereof.

9. A method for producing laminated structures comprising:
providing a polyurethane system comprising at least a composition comprising from 0.1 to 20% by mass based on the total composition of an additive mixture, said additive mixture comprising at least one organic phosphorus compound (I) selected from compounds of formulae (Ia) to (Ic) 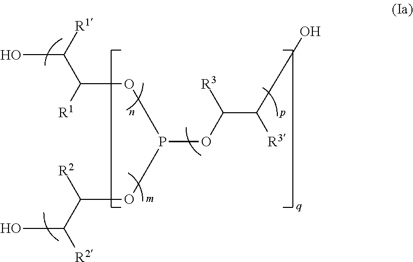
where m, n and p are identical or different and are each greater than or equal to 1,
q is greater than or equal to 1, and
R′, R^{1′}, R², R^{2′}, R³ and R^{3′} are identical or different and are each —H, -alkyl or -phenyl, 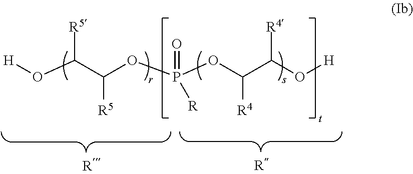
where the indices r are identical or different and are each greater than or equal to 1,
the indices s are identical or different and are each 0 or greater than or equal to 1,
t is greater than or equal to 1,
R⁴, R^{4′}, R⁵ and R^{5′} are identical or different and are each —H, -alkyl or -phenyl,
R is a hydrogen radical, alkyl radical, phenyl radical, R″ or R′″ and
r+s is from 4 to 60, and 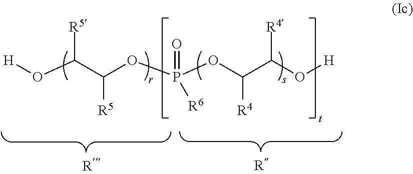
where r, s, t, R⁴, R⁵, R^{4′}, R^{5′}, R″ and R′″ are as defined for formula (Ib) and R⁶ is —(CH₂)ₒ—OH, where o is from 1 to 5,
and at least one compound (X) which has at least two functional groups capable of reacting with isocyanate groups (isocyanate-reactive groups) and has an equivalent mass of less than 400 g/mol, or of an additive mixture consisting of one or more compounds of the formula (Ic); and
bonding said polyurethane system to a surface of a substrate.

10. A polyurethane including at least a composition according to claim 1.

11. A polyurethane foam comprising at least a composition according to claim 1.

12. A laminated structure comprising a polyurethane system hot adhesively bonded to a substrate, said polyurethane system comprising at least a composition including from 0.1 to 20% by mass based on the total composition of an additive mixture, said additive mixture comprising at least one organic phosphorus compound (I) selected from compounds of formulae (Ia) to (Ic) 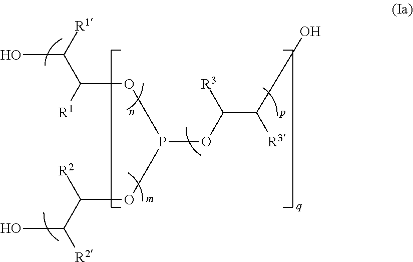
where m, n and p are identical or different and are each greater than or equal to 1,
q is greater than or equal to 1, and
R¹, R^{1′}, R², R^{2′}, R³ and R^{3′} are identical or different and are each —H, -alkyl or -phenyl, 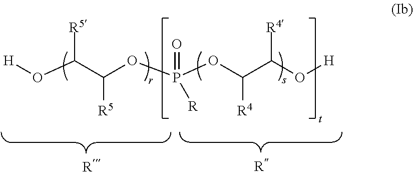
where the indices r are identical or different and are each greater than or equal to 1,
the indices s are identical or different and are each 0 or greater than or equal to 1,
t is greater than or equal to 1,
R⁴, R^{4′}, R⁵ and R^{5′} are identical or different and are each —H, -alkyl or -phenyl,
R is a hydrogen radical, alkyl radical, phenyl radical, R″ or R′″ and
r+s is from 4 to 60, and 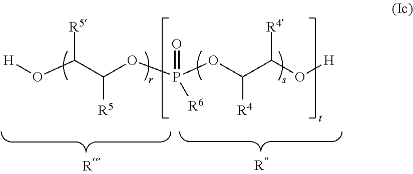
where r, s, t, R⁴, R⁵, R^{4′}, R^{5′}, R″ and R′″ are as defined for formula (Ib) and R⁶ is —(CH₂)ₒ—OH, where o is from 1 to 5,
and at least one compound (X) which has at least two functional groups capable of reacting with isocyanate groups (isocyanate-reactive groups) and has an equivalent mass of less than 400 g/mol, or of an additive mixture consisting of one or more compounds of the formula (Ic).

13. The method according to claim 9, wherein said bonding includes hot adhesive bonding.
